(19) United States
(12) Patent Application Publication
(10) Pub. No.: US 2013/0037537 A1
(43) Pub. Date: Feb. 14, 2013

(54) DEVICE FOR HEATING LIQUIDS

(71) Applicants: Manfred Sturz, Pemfling (DE); Olaf Kunkel, Untermeitingen (DE)

(72) Inventors: Manfred Sturz, Pemfling (DE); Olaf Kunkel, Untermeitingen (DE)

(21) Appl. No.: 13/580,187

(22) PCT Filed: Feb. 3, 2011
(86) PCT No.: PCT/EP2011/051529

§ 371 Date: Oct. 26, 2012

(30) Foreign Application Priority Data
Feb. 23, 2010 (DE) 102010009136.7

(51) Int. Cl. A47J 37/12; H05B 6/12; H05B 6/06

(52) U.S. Cl. 219/628

(57) ABSTRACT

A device for heating liquids, has a frame in which a container for receiving a liquid medium is arranged, wherein at least some sections of the container are formed of a current-conducting material. The device includes an induction unit generating a magnetic field. The induction unit is arranged outside the container such that it applies a magnetic field to at least one outside wall of the container. At least one section of the container is formed of a composite material, wherein one of the components contains aluminum and the second component contains a material different from aluminum.

The present invention relates to a device for heating liquids. The invention is described with reference to a fryer, but it is pointed out that the present invention may also be suitable, where applicable, for other heating devices such as for example devices for heating water for pasta or the like.

In the prior art such fryers usually have containers in which a frying liquid, such as in particular oil, is heated. An electric element which is disposed within the container and heats the oil usually serves for heating. A satisfactory frying result is achieved in this way. Nevertheless it is sometimes very laborious to clean corresponding electric heating means after use, since they naturally come into contact with the frying liquid.

Furthermore fryers are also known from the prior art which have burners, in particular gas burners, which heat the said container. However, in commercial application such fryers are in particular always dependent on a gas connection.

An induction frying device is known from WO 2008/089590 A2. This device has a frying container with a cold zone and an induction coil in each case in a base region and in a lateral region of the frying container. Furthermore a temperature measuring device is provided, wherein an adjusting unit controls the individual heating elements of this induction frying device individually. In particular in this device a temperature measuring device is assigned precisely to each induction coil. The device described in WO 2008/089590 A2 makes it possible to control the individual induction coils, but it has a relatively complicated configuration in terms of control engineering because of the plurality of heating elements and in particular also the individual assignment of a plurality of temperature measuring devices to the individual heating elements.

Accordingly in the case of WO 2008/089590 A2 a plurality of induction coils are provided which should achieve a uniform heating of the food for frying. However, this procedure is relatively complex. The object of the present invention therefore is in particular to increase the heating efficiency for such devices. Also the costs for induction fryers should be reduced. This is achieved according to the invention by a device as claimed in Claim 1. Advantageous embodiments and modifications are the subject matter of the subordinate claims.

A device according to the invention for frying has a frame in which a container is disposed to hold a liquid medium. In this case the container consists at least in some sections of a current-conducting material and the device has an induction unit which generates a magnetic field, wherein this induction unit is disposed outside the container in such a way that it applies a magnetic field to at least one outer wall of the container for heating the liquid.

According to the invention the container has a composite material at least in some sections and in particular at least in one section to which the magnetic field is applied by the induction unit, wherein one of the components of this composite material contains aluminium or is respectively made from aluminium and a second component of the composite material which is different from aluminium. The second component preferably contains a ferromagnetic material.

It is therefore proposed, not as usual hitherto in the prior art, to produce the said container from a material, for example from steel, but from a plurality of components which co-operate in a particularly advantageous manner In principle aluminium would be particularly suitable, since it is a very good conductor of heat. The disadvantage of aluminium is that in particular it is not suitable for the use of inductive heating units. This object is undertaken by the second component which includes the material which is different from aluminium. In this case in particular the second component includes a magnetic material which reacts to the magnetic field of the induction device.

The second material is advantageously selected from a group of materials which includes steel, stainless steel, titanium nickel alloys, copper, combinations thereof and the like.

The inner wall of the container is advantageously made from the further component. In this case it may be particularly advantageously provided that the first component is present in a layer lying between two further layers of the second component. The container is advantageously produced completely from the said composite material and in this case in its entirety it preferably has the said three layers. Further layers such as an insulating layer, varnish layers and the like may optionally be provided. In this way by the use of the central aluminium layer a quick distribution of heat can be achieved over the entire container even if the heating via the magnetic field only takes place in one region. Thus, a composite material is understood to be layers of different materials advantageously disposed above one another.

The wall of the container, that is to say the entire composite material, preferably has a thickness between 8 mm and 30 mm, preferably between 10 mm and 25 mm and particularly preferably between 10 mm and 20 mm Complex investigations were able to determine that the said layer thicknesses are suitable in a special way to meet the different requirements concerning stability, thermal conductivity and heat transfer to the liquid.

In a further advantageous embodiment the device has a controllable valve and particularly preferably it has a water solenoid valve in order to introduce a liquid, such as in particular water, into the container. In this case this valve is also advantageously suitable for the introduction of pressurised media. In this way it is for example possible to refill the container with liquids such as water. In a further advantageous embodiment the device has a first sensor unit which detects a first physical state of the liquid medium or of the container, and also preferably an adjusting unit which adjusts the output of the induction unit as a function of an output signal of this sensor unit. This sensor unit may for example be a filling level sensor which detects a filling level of the liquid within the container. In addition, however, temperature sensors may also be provided.

The device advantageously has a second sensor unit which detects a second physical state of the liquid medium or of the container, wherein the adjusting unit adjusts the output of the induction unit as a function of an output signal of the second sensor unit.

The material of the container is advantageously configured in such a way that above a certain temperature its magnetic properties change for example from a ferromagnetic state into a paramagnetic state. With such coatings it is possible to combine them so that the Curie temperature of the connection can be changed. In this way it is possible that, in the event of overheating, a physically determined switching off of the device is enabled, since the composite material no longer reacts to the induction coils. Depending upon the specific application, it is possible to configure the material compounds of the container in such a way that the Curie temperature can change within certain limits The combination of the material is preferably designed in such a way that the Curie temperature is in the region of approximately 190° C.

In this case it is possible, that the temperature of the liquid medium, such as for example a frying oil, is measured directly. However, it would also be possible for indirect measurements to be carried out for example of the outer wall of the container or also the inner wall of the container. The output of the induction unit is in particular electrical power or heating power respectively. At least two sensor units which are independent of one another are preferably provided which supply the input signals for the control unit. The two sensors are advantageously spaced apart relative to one another, for example one sensor in a lower region of the container and a further sensor in an upper region.

At least one sensor unit is advantageously disposed in a wall of the container. Thus may for example a bore may be provided in said wall, and the temperature measuring unit may in turn be disposed in this bore.

In an advantageous embodiment the first sensor unit and the second sensor unit operate according to different physical measurement principles. This will be understood to mean that the two control units react to different physical states. Thus the first sensor unit may for example be a temperature sensor such as a PT 100 resistance and the second sensor unit may for example be an optical sensor unit, by means of which any foaming of the liquid can be detected. Thus, it is possible for example that, if foaming of the frying oil is detected, the heating power of the induction unit is immediately throttled.

In this case it should be noted that frying fat which foams in such a way is associated with high risks for the user. Advantageously at least one sensor unit is a temperature measuring device which determines the temperature of the liquid medium at least indirectly. Thus, for example the first sensor unit may be a temperature sensor PT 1000 which is screwed onto the container or onto the adjusting unit for example by way of a thread. Temperatures up to 250° can advantageously be measured by this temperature measuring unit.

At least one sensor unit advantageously detects a filling level of the liquid medium in the container. This may for example be an optical sensor or an optoelectronic limit switch or opener respectively which specifies the filling quantity or a maximum value for the filling quantity respectively so that, if the flying food starts to foam, the induction unit can be throttled and the frying fat cannot overcook. However, it would also be possible for this optical sensor unit to be used so that it indicates a minimum value of the frying liquid. The responsiveness of this sensor unit is advantageously adjustable. This sensor unit is also preferably screwed into the container, for example by means of ½-inch threads. However, the sensor unit may also be disposed on the adjusting unit.

Thus in a further advantageous embodiment at least one sensor unit is disposed on or in a wall of the container.

In a further advantageous embodiment the device has a third sensor unit which detects a physical state of the liquid medium or of the container. In this case this may be a sensor unit which is a component of a safety temperature limiter which may preferably be adhered or fastened on the outside of the container.

In a further advantageous embodiment the adjusting unit is a so-called ACS adjuster.

In a further advantageous embodiment at least one further induction unit is provided on at least one side of the container. These induction units can be controlled by the said first and second sensor units. The generators for supplying the induction coils are preferably disposed in the frame below the container. In this case the adjustment can be effected by means of an on/off switch and also by means of a potentiometer which digitally transmits the number of degrees by means of the ACS adjuster.

The device advantageously has a display unit which indicates the respective status of the heating units or the frying liquid respectively. Thus, for example three visible colour-marked graduations identified by colour are provided which indicate the heating status, a status in which the desired temperature is reached and, if appropriate, also an over-temperature status (for example, red).

The container preferably has at least one flat wall and the induction unit is disposed adjacent to this wall. In this way an electrical field, more precisely an alternating magnetic field, can be transmitted via this flat wall. This magnetic alternating field is converted into heat in this wall. More precisely, in the container or the said flat surface respectively the induction unit induces induction eddy currents which heat the metal of the container and from there, by heat transfer, also liquid disposed within the container, such as for example frying oil.

An arrangement of the induction unit adjacent to the container is understood in particular to mean that a spacing between the induction unit, or an element of the induction unit transmitting the magnetic field transferred respectively and the container is less than 20 cm, preferably less than 10 cm, preferably less than 8 cm. The spacing between the induction unit and the container is particularly preferably less than 5 cm and particularly preferably less than 3 cm. Particularly preferably the spacing between the container and the inductive material of the coil is 9-12 mm

The wall of the container is preferably a base surface of the container. In this way the oil or the frying liquid respectively can be heated from below and in this way the heat penetrates the frying liquid completely. Thus in this preferred embodiment the induction unit is disposed below the said base surface of the container. However, it would also be possible for the induction unit to be disposed on a side face of the container.

A material-free space is preferably formed between the induction unit and the container. However, it would also be possible for an insulating member to be disposed in this space for in particular thermal insulation, but optionally also electrical insulation of the coil. Such induction units are known for example from induction hobs. In these induction hobs the induction unit is separated for example from a pan by a glass ceramic. This glass ceramic is not inevitably necessary in the present case, so long as it is ensured that there is a predetermined spatial ratio between the container and the induction unit. This is preferably achieved in that the induction unit is firmly disposed in the frame and also the container is disposed at least in an inserted state in a spatially precisely defined position.

Therefore at least a small air gap is formed between the induction unit and the container. An insulating member is also preferably disposed in this region in addition to or instead of the air gap for thermal insulation of the induction coil. This insulation protects the induction unit from heating by the container or the frying food respectively.

In a further preferred embodiment the container is made at least in some sections from a ferromagnetic material. Although induction heating in principle would be possible in all metallic, i.e. current-conducting materials, a container made from ferromagnetic material is advantageous for sufficiently good functioning. The magnetic alternating field of the corresponding induction units propagates in all directions without containers and is even repelled by very conductive but non-ferromagnetic containers. The use of ferromagnetic material leads to a focusing of the magnetic field, so that the emitted electromagnetic energy is transmitted in a targeted manner into the electrically conductive lower surface of the container. In this way on the one hand the necessary field is getting smaller, on the other hand the radiation into the environment is reduced.

In a further advantageous embodiment the container is removable from the frame. Cleaning of the container is also made easier in this way. However, it would also be possible for the container to be firmly disposed in the frame, or for example it can only be removed from the frame by loosening one or more screws.

The container preferably has such stability that at least the base of the container, or the surface which lies opposite the induction unit respectively, does not bow or only bows slightly under the weight of the frying liquid. In this way the base of a filled container can be prevented from contacting the induction unit.

In a further advantageous embodiment the output of the induction unit is controllable. In this way the temperature of a medium or of the frying liquid respectively can be adjusted as required.

In a further advantageous embodiment the induction unit has a coil. Thus, for example, a large, flat, single-layer coil made from a high frequency litz wire can be provided which generates the magnetic alternating field below the container.

In a further preferred embodiment the container and the coil are made from different materials. Thus it is advantageously provided that the ferromagnetic material of the container has a sufficiently higher specific electrical resistance than the material of the said induction coil, wherein the material thereof is in particular copper. Thus, for example, a container may be made from iron.

Furthermore, the device preferably has a damping unit which damps movements of the container relative to the frame. In this case it should be noted that noise can be generated on the container by the induction unit and this can lead to vibration of the container. The said damping unit may effect damping of vibrations of the container. In this case it is possible for such damping units to act on the same surface of the container on which the induction unit is also disposed.

However, it would also be possible for the container as a whole to be damped relative to the frame or for resilient supports to be provided respectively. In particular in those cases in which the container is firmly installed in the frame such damping members which damp the container relative to the frame may be already firmly integrated. In this case it would also be possible for the container to be constructed in two parts stated is and that damping units are provided between the surface of the container which is acted upon by the magnetic field and the remaining part of the container.

The frame is preferably produced at least in some sections from a non-current-conducting material. In the region in which the said coil is disposed the frame is advantageously made from a non-current-conducting material and in particular a non-ferromagnetic material, so that unwanted heating of the frame in this region can be prevented. However, it would also be possible for the frame to be made from a possibly current-conducting but non-ferromagnetic material and, as mentioned above, in this way for the magnetic field to be introduced substantially only into the container. In a further advantageous embodiment the device has a plurality of induction units. Thus, it is possible for a plurality of induction units to be disposed below a base surface. However, it would also be possible for a plurality of induction units to be disposed on a plurality of side faces of the container.

In a further advantageous embodiment the induction unit or the coil respectively is disposed obliquely, and also the said surface which is heated by the induction unit is preferably disposed obliquely. In this way, for switching off the device the frying liquid can flow off and thus a certain self-cleaning effect can be achieved.

The device preferably also has a drain for a frying liquid, wherein this drain is preferably disposed below the said base surface and preferably also below the induction unit. In this way soiling of the induction unit by frying liquid running out can be prevented.

In further advantageous embodiments the device has an operating device for operating the induction unit. This operating device is advantageously designed as a keyless operating device. The use of such touch panels is especially suitable for the present device, since the risk of soiling of operating elements can be reduced in this way. In this case by means of this operating device a desired temperature of the fluid can be set in the interior and optionally a power for the induction unit can be set.

The device advantageously has a controller which is sealed relative to the environment, for example by means of a ceramic glass fitted in a watertight manner. In addition, the operating device advantageously has a display unit, in order to output certain parameters to the user, such as for example a liquid temperature, or information about whether heating has just taken place.

Thus, it would be conceivable for the operating device to have two keys or operating elements respectively for changing the temperature. Three further keys could be assigned to preset temperature values (e.g. for different frying food). In this case these predetermined temperature values are advantageously adjustable by the user.

Furthermore, it would be possible for two temperature points to be predetermined for the controller, and the induction unit ensures that the temperature of the liquid always lies between these values. As mentioned above, the temperature measurement in the material of the tank base and in particular in the base region advantageously takes place via the coil. In this case a sensor unit is disposed particularly preferably in the aluminium layer or respectively preferably on the aluminium layer. This is particularly advantageous, since the distribution of heat is most favourable in the region of the aluminium layer.

In addition the operating device could have a further operating element in order to operate the above-mentioned valve by which the delivery of a liquid into the container is controlled. In this way the user can allow a liquid such as for instance water to run on into the container as required.

In addition an optical sensor which registers excessive foaming can be provided in the container.

Further advantages and embodiments are apparent from the appended drawings: In the drawings:

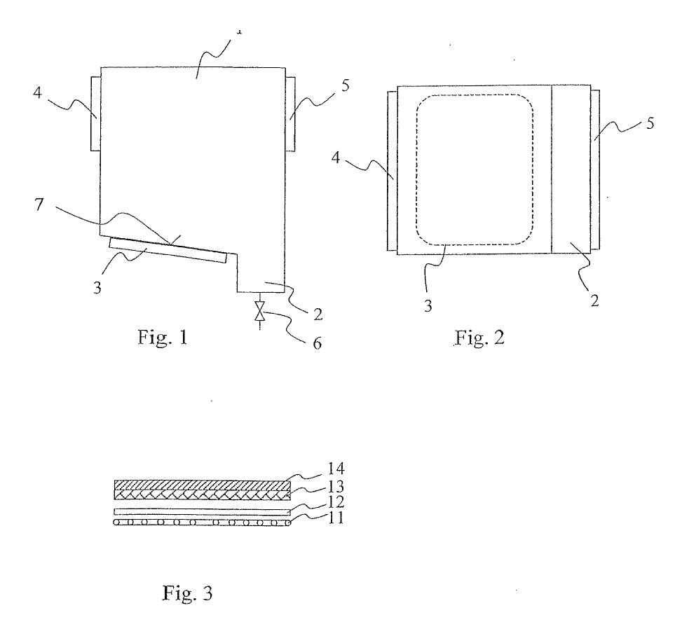

FIG. 1 shows a cross-sectional representation of a device for frying according to the invention;

FIG. 2 shows a more detailed representation of an induction unit;

FIG. 3 shows a wiring diagram of a device according to the invention; and

FIG. 4 shows a representation of a section of the container 4.

FIG. 1 shows a cross-sectional representation of a device 1 according to the invention for frying foodstuffs. This device 1 has a frame which has side walls 2a and 2b and a support 20 for holding a container 4. Thus, the frame 2 forms an opening 22 through which the container 4 can be inserted. In this case the container is held securely by means of the said support 20, in which a collar 24 of the container 4 engages. In this region it would be possible to provide switching means 28 which allow operation of an induction unit 6 only if the container 4 is correctly inserted. It would also be possible to configure the switching means in such a way that only special containers switch it and in this way enable operation of the induction unit 6. The container may also be disposed in a fixed manner or may be releasable or removable respectively from the frame by screws.

The container 4 has a base surface 4a and a plurality of side faces 4b and 4c. In this case the base surface 4a is flat and extends obliquely, wherein it is angled here relative to a horizontal direction by an angle in the region of 10°. By way of this oblique base surface 4a a frying liquid can flow off after use of the fryer in the direction of a receiving chamber 32 and can be drawn off if appropriate via a drain 26.

An induction unit which is designated by 6, and which heats the base surface 4a and thus also the contents of the container 4, is disposed below the base surface 4a. In this case this induction unit 6 has a coil 12 and a temperature measuring device which is disposed in the centre of the coil 12 here. In this case this temperature measuring device or a region thereof respectively projects in the direction L (cf. FIG. 1) slightly beyond the coil 12 and thus serves simultaneously as a spacer which spaces the base surface 4 from the induction unit. In this way the material of the base surface 4a can be prevented from directly contacting the coil 12. However, it would also be possible for a plurality of such spacers, for example three spacers, to be provided which ensure a sufficient minimum spacing between the coil and the base surface 4a. It would also be possible for the coil to be covered with a protective coating which also prevents a direct contact between the metal of the coil and the metal of the base surface 4a.

The reference 34 relates to a further switching means which may be disposed for example on the induction unit 6 and which is only switched on when a container is correctly inserted into the device 1. Thus, a part of the container 4 is disposed within the frame, wherein this part makes up the substantial volume of the container 4 and a further part of the container 4, in particular the upper edge thereof, is disposed outside or above the frame.

However, it would also be possible for the container 4 to be supported by way of its base surface 4a. In this case supports could be provided below the base surface. Such supports could also have damping elements (not shown) in order to damp vibrations of the base surface 4a generated in particular by induction. There could also be a fixed connection between the induction unit 6 and the container 4. Thus, the induction unit 6 could be configured as a plug-in module which can also be removed from the frame 2. In this way it would also be possible to retrofit the induction unit in already existing fryers. Therefore, the present invention is also directed to the use of an induction unit and in particular an induction unit of the type described above for fryers and in particular fryers which can be used commercially.

The reference numeral 42 relates to a first sensor unit which here detects the temperature of the liquid in the container 4. In this case this sensor unit 42 is disposed in a side wall 4b, but it would also be possible for example to dispose this sensor unit in the base 4a of the container or in the other side wall 4c.

A filling level of the liquid, i.e. of the frying food can be detected by means of a second sensor unit 44. This may for example be an optical sensor, such as a light barrier, which detects whether the liquid boils over.

These two sensor units 42 and 44 are in contact with an adjusting device 40 which in turn controls the induction unit 6, more precisely the output of this induction unit 6. As mentioned, further induction units could also be disposed on the side walls 4c and 4b, wherein the adjusting unit 40 could preferably also control these further induction units (not shown).

FIG. 2 shows a more detailed representation of an induction unit 6. In this case the reference numeral 12 again relates to a copper coil, in the centre of which a temperature measuring device 14 is disposed. The reference numeral 16 identifies a cooling unit for cooling the coil and the corresponding electronics. The reference numerals 17 relates to the capacitors of the resonant circuit for operating the induction unit 6 and the reference numeral 18 relates to a mains filter. Instead of the embodiment shown in FIG. 2 it would also be possible to dispose a plurality of coils in order in this way to cover the rectangular surface more favourably. It would also be possible that the coil 12 does not have a circular cross-section but an elliptical cross-section.

FIG. 3 shows a simplified representation of a possible circuit for operating a device according to the invention. The reference numeral 50 relates to a current supply (three-phase in this case), which delivers electrical power to the induction unit designated as a whole by 6. The reference numeral 6a identifies an electrical coil to be supplied with power. With the aid of a temperature measuring device 64 or a sensor respectively the temperature of the coil is measured and, if need be, cooling 62 is activated. The reference numeral 41 relates to a switching means for switching the fryer according to the invention on and off. The heating output can be regulated with the aid of a potentiometer 43. The reference numeral 48 identifies a fuse.

An ACS adjuster designated as a whole by 40 is provided for adjusting the device. Such ACS adjusters usually have a display unit, as here, for example for output of a temperature. The advantage of such an ACS adjuster consists in its high working speed, wherein it is possible for all the adjustment parameters to be set by means of software. It is also possible for the ACS adjuster to be provided with an external potentiometer as desired value setting. The display of the adjuster is preferably able to change colour, the respective threshold values being adjustable. Thus, for example, orange may indicate that an actual value lies below the desired value, green may indicate that the actual value corresponds to a desired value, or red may indicate that the actual value exceeds the desired value. In this case, an alarm can also be emitted.

The reference numeral 42 relates to a temperature sensor which is connected to the ACS adjuster. This temperature sensor 42, which is the first sensor unit described above, can measure a temperature of the frying liquid or also of the container and the heating means 6 can be controlled correspondingly in reaction to the measured temperatures. The reference numerals 52 and 53 relate respectively to switching relays.

The reference numeral 44 identifies a further measuring device as a whole, which here is the second sensor unit described above. This second sensor unit can measure a filling level of the liquid within the container and can pass on the corresponding measurement results to a switching means 45, which in turn correspondingly controls the heater 6. The reference numeral 53 identifies a lighting means, which for example indicates a specific switching state of the device. The heating means 6 can again be controlled by means of a further relay 61.

In this case the measuring device can detect both a minimum and a maximum filling level of the frying liquid.

FIG. 4 shows a sectional representation of a portion of a container 4. The container as a whole is advantageously constructed in the manner shown in FIG. 4. It will be recognised that the wall 60 of the container 4 is made up of a plurality of layers 65, 66 and 68 disposed above one another. In this case the reference numeral 64 relates to a stainless steel layer which here faces the interior of the container and thus also the liquid to be heated.

The reference numeral 68 identifies a further stainless steel layer which here faces the induction unit (not shown) or is respectively directed outwards. The two steel layers 65 and 68 can be heated by the induction unit. In addition these two layers also contribute to the stability of the container 4. An aluminium layer 66 is disposed between the two steel layers 65 and 68. This aluminium layer 60 serves for better distribution of heat, which is advantageous in particular when only one induction unit is present. Thus these said layers form the composite material referred to in the introduction.

Optionally a further layer 70, such as for instance a protective coating, can be provided on the stainless steel layer 65. It would also be conceivable also to provide a further layer below the lower layer 68. The thickness of the two layers 64 and 68 is between 1 mm and 10 mm, preferably between 1 mm and 8 mm and particularly preferably between 1 mm and 6 mm The thickness of the aluminium layer is between 3 mm and 15 mm, preferably between 4 mm and 12 mm and particularly preferably between 4 mm and 10 mm.

The reference numeral 69 identifies a recess which is disposed in the wall and in which a temperature sensor 42 is disposed. In this case the recess extends into the region of the aluminium layer 66, so that the temperature can be measured in this region.

In a particularly advantageous embodiment the aluminium layer has a greater thickness than at least one of the two other layers 64, 68 and preferably greater than the two other layers 64 and 68 and preferably at least twice the thickness, preferably at least 3 times the thickness, preferably at least 5 times the thickness, and particularly preferably at least 6 times the thickness.

In this case the aluminium layer, as mentioned above, distributes the heat as uniformly as possible and in particular also to regions which are not directly heated by the induction unit. Preferably only a part-region of the container 4 or of the base surface 4a thereof respectively is acted upon directly by the induction unit 6 and in particular the aluminium layer ensures the uniform distribution of the heat to the entire container and preferably also to the side faces 4b, 4c of the container 4. Therefore, the base surface 4a of the container is preferably greater than the surface of the induction unit opposite this base surface, and particularly preferably this base surface is at least 1.5 times the size, preferably at least 2 times the size and particularly preferably at least 3 times the size of the induction unit.

Therefore, it is possible, in particular due to the configuration of the aluminium layer, to effect a uniform distribution of heat even if the induction units are substantially smaller relative to the base surface of the container. The container is advantageously (at least in the range the base surface and preferably overall) constructed integrally with the thickness ratio of the layers 64, 66 and 68 described here.

Further lore, the individual layers are advantageously constructed—in particular co-ordinated with the adjustment—in such a way that the inner face of the container or of the base respectively does not exceed a specific temperature. This temperature is preferably at most 240° C. The medium located in the container should preferably not exceed a temperature of 180° C. Furthermore, however, rapid heating of the medium should be possible. Whereas adjustment means known in the prior art only switch on or off, the adjustment means of the present device is advantageously designed in such a way that the temperature of the liquid slowly approaches the set value.

The closer the actual temperature of the medium is to the desired temperature, the slower is the further approach to this desired temperature. A sensor unit which detects the temperature of the liquid in the container is advantageously provided in the container. In this case this sensor unit may for example be disposed on the base of the container. Therefore the adjusting unit 40 is preferably configured in such a way that it controls the heating means also as a function of the temperature of the medium and in this case in particular control is possible with more than two power stages. In this case the said sensor unit for detecting the temperature of the medium can also ascertain whether medium is actually in present in this container. If this sensor unit ascertains that there is no medium or too little medium in the container, the electrical power supply to the induction unit can be interrupted.

In order on the other hand to achieve rapid heating of the medium, the adjusting unit is configured in such a way that there is a predetermined temperature difference between the temperature of the base and the medium. This temperature difference decreases as the desired temperature is approached.

Since the multi-layer material described above enables the temperature to be transferred uniformly and smoothly to the medium, the underside of the multi-layer material can be strongly heated, but should nevertheless be adapted to the amount of aluminium or to the thickness of the aluminium layer respectively. The temperature of this heating of the lower layer 68 is 300° C., and this temperature can be reduced accordingly as the target temperature of the medium is approached.

A third temperature sensor 14 is located, as mentioned above, in the coil. This serves in particular for the protection of the coil and switches the electrical power supply off when the temperature exceeds 190° C. at this point. However, due to the very good insulation between the underside of the multi-layer material and the coil this temperature is not transferred from the multi-layer material.

Furthermore a current limiter can be provided which is mounted for example on the outer face of the container and can register when the temperature of the medium of 240° C. is exceeded and in this case can switch off the electrical power supply.

Advantageously, the control of the temperatures cannot be influenced from the outside, except for the gradual adjustment of the temperature in the medium. This may be adjusted gradually on the panel by the operator.

Thus, 2 keys can preferably be provided for increasing or respectively decreasing the temperature, as well as three further keys with fixed set temperatures (preferably 80, 100 and 170° C.). Furthermore, the adjustment means can be set to a maximum temperature of e.g. 180° C. Furthermore, different programs can be programmed and set via the panel. This applies for example to an automatic lifting system for the fryer basket after a specific time and other similar controls.

All the features disclosed in the application documents are claimed as essential to the invention in so far as they are individually or in combination novel over the prior art.

### List of Reference Numerals

1 device

2 frame

2a,b side walls

4 container

4a base surface

4b,c side faces

6 induction unit

6a coil

12 coil

14 temperature measuring device

16 cooling unit

17 capacitors

18 mains filter

20 support

22 opening

24 collar

26 drain

28, 34 switching means

32 receiving chamber

40 ACS adjuster, adjusting unit

41 switching device

42 temperature sensor

43 potentiometer

44 measuring device

45 switching means

48 fuse

50 current supply

52, 53 switching relay

54 lighting means

61 relay

62 cooling

64 temperature measuring device

60 wall

65, 68 stainless steel layers

66 aluminium layer

69 recess

70 further coating

L direction

1-10. (canceled)

11. A device for heating liquids, with a frame in which a container is disposed in order to receive a liquid medium, wherein the container is formed at least in some sections of a current-conducting material and the device has an induction unit which generates a magnetic field, wherein this induction unit is disposed outside the container in such a way that it applies a magnetic field to at least one outer wall of the container, wherein the container is formed of at least a composite material in at least one section, wherein one of the components of this composite material contains aluminum and a second component of this composite material contains a material which is different from aluminum, and wherein the first component is present as a layer between two further layers of the second component.

12. The device as claimed in claim 11, wherein a layer thickness of the first component is greater than the layer thickness of at least one second component.

13. The device as claimed in claim 11, wherein the second material is selected from a group of materials consisting of steel, stainless steel, a titanium nickel alloys and copper.

14. The device as claimed in claim 11, wherein an inner wall of the container is made from the second component.

15. The device as claimed in claim 11, wherein the device has a first sensor unit which detects a first physical state of the liquid medium or of the container.

16. The device as claimed in claim 15, wherein the device also has an adjusting unit which adjusts the output of the induction unit as a function of an output signal of this sensor unit.

17. The device as claimed in claim 11, wherein at least one sensor unit is a temperature measuring device which determines the temperature of the liquid medium.

18. The device as claimed in claim 11, wherein at least one sensor unit detects a filling level of the liquid medium in the container.

19. The device as claimed in claim 11, wherein the device has an operating device for operating the induction unit and this operating device is designed as a keyless operating device.

20. The device as claimed in claim 11, wherein a temperature measuring device which measures a temperature of the aluminum component is integrated into a wall of the container.

21. The device as claimed in claim 11, wherein the composite material comprises a thickness which is between 8 mm and 30 mm.

22. The device as claimed in claim 11, wherein the composite material comprises a thickness which is between 10 mm and 25 mm.

23. The device as claimed in claim 11, wherein the second composite comprises a thickness which is between 10 mm and 20 mm.

24. The device as claimed in claim 11, wherein the second composite comprises a thickness which is between 1 mm and 10 mm.

25. The device as claimed in claim 11, wherein the composite material comprises a thickness which is between 1 mm and 8 mm.

26. The device as claimed in claim 11, wherein the composite material comprises a thickness which is between 1 mm and 8 mm.

27. The device as claimed in claim 11, wherein the composite material comprises a thickness which is between 3 mm and 15 mm.

28. The device as claimed in claim 11, wherein the composite material comprises a thickness which is between 4 mm and 12 mm.

29. The device as claimed in claim 11, wherein the composite material comprises a thickness which is between 4 mm and 10 mm.
